(19) United States
(12) Patent Application Publication
(10) Pub. No.: US 2007/0194050 A1
(43) Pub. Date: Aug. 23, 2007

(54) Metering device with locking action

(76) Inventors: Gerald Krampen, Radolfzell (DE); Christa Wohriska, Steisslingen (DE); Judith Auerbach, Radolfzell (DE)

Correspondence Address: FLYNN THIEL BOUTELL & TANIS, P.C., 2026 RAMBLING ROAD, KALAMAZOO, MI, 49008-1631, US

(21) Appl. No.: 11/701,241

(22) Filed: Feb. 1, 2007

(30) Foreign Application Priority Data
Feb. 2, 2006 (DE) 102006005954.9

(51) Int. Cl. B67D 5/00; B67B 5/00

(52) U.S. Cl. 222/153.13

(57) ABSTRACT

The invention relates to a metering device for manual, in particular single-handed metering of a medium, having a pump device which can be operated by means of a pump movement in order to feed the medium and is assigned a metering head which has an actuating device which is moveably coupled to the pump device in order to introduce the pump movement along a pump movement axis. It is provided according to the invention that at least one section of the metering head, in particular the actuating device, has an integrated metering duct for transporting the fed medium from the pump device to a metering opening, and is moveable between a rest position and a functional position in order to block or unblock the actuating device for the pump movement.

The invention relates to a metering device for manual, in particular single-handed metering of a medium, having a pump device which can be operated by means of a pump movement in order to feed the medium and is assigned a metering head which has an actuating device which is moveably coupled to the pump device in order to introduce the pump movement.

A dispensing device for a medium is known from DE 101 34 796 A1, which dispensing device has a metering head, which can be actuated for a dispensing process, and a carrier unit which is assigned to the metering head. The carrier unit can be fastened to an outlet region of a storage container for the medium. The metering head can be locked in a blocking position, and cannot be actuated in said position, by means of two locking means in the form of latching lugs formed on opposite sides of a securing part. For this purpose the latching lugs have, in the region of an inner face edge, in each case one latching cam which is assigned in each case one corresponding latching cut-out on the metering head.

The object of the invention is that of producing a metering device which is protected against unintended use in a simple, reliable and comfortably manageable way.

Said object is achieved by means of a metering device of the type stated in the introduction, in which at least one section of the metering head, in particular the actuating device, has an integrated metering duct for transporting the fed medium from the pump device to a metering opening, and is moveable between a rest position and a functional position in order to block or unblock the actuating device for the pump movement.

The metering head can have a plurality of sections which are moveable relative to one another. Typically, at least one section of the metering head is rigidly connected to the pump device or to a medium store, and thereby permits guidance, in particular sliding or rotary guidance, of at least one further relatively moveable section of the metering head. Said further section can in particular be embodied as an actuating device for the pump device, and can serve as a finger rest for one or more fingers of an operator. It is possible by means of the finger rest for a pressure force to be introduced into the actuating device and therefore into the pump device, in order to bring about a pump movement. The pump device can in particular be embodied as a piston pump and makes it possible to feed a predefinable quantity of the medium.

Provided in a relatively moveable section of the metering head is a metering duct, that is to say a preferably elongate cavity which is open at least at the end sides, which runs from an outlet opening of the pump device to a metering opening. The outlet opening of the pump device is provided for an ejection, that is to say a discharge of a medium quantity fed as a pump movement is carried out. The metering opening is provided for discharging the fed medium quantity to the surroundings. The medium duct and the metering opening can be matched with regard to a profile cross section and an opening cross section to a viscosity of the medium in order to permit reproducible medium metering. In this case, the profile of the metering duct is designed in the manner of a capillary and the metering opening is configured in particular as a narrowed nozzle opening with a nozzle profile for vaporizing the medium or to discharge the medium in a spray jet. The medium can in particular be a high-viscosity gel- or cream-like cosmetic or pharmaceutical substance which is metered in the manner of a strand of paste or cream, such as out of a toothpaste tube or a cream tube. In this case, the profile cross section of the metering duct is preferably cylindrical, and the metering opening widens slightly towards the outlet if required. The metering duct can be integrally formed in a section of the metering head, though a multi-part design of the metering duct is likewise conceivable, for example with a nozzle insert, which is matched to the medium, in the region of the metering opening and/or with a plurality of metering duct sections. The medium can also be an aqueous solution of one or more pharmaceutical substances.

The mobility of at least one section of the metering head relative to other sections of the metering head between the rest position and the functional position provides the blocking and unblocking of the actuating device. When the actuating device is blocked, no pump movement, or at least only a small pump movement which does not lead to a relevant metering of medium, is possible for any introduction of actuating force, for example on the finger rest. It is therefore possible to prevent a discharge of medium, and if appropriate to prevent soiling, as a result of an unintended introduction of force into the metering device as the metering device is being transported. An unintended introduction of force can in particular occur when the metering device is being transported in a handbag or a carrier bag in which the metering device is transported together with other objects.

After a movement of the corresponding section of the metering head from the rest position into the functional position, the introduction of an actuating force into the actuating device leads to an actuation of the pump and therefore to a metering of medium. In a preferred embodiment of the invention, it is provided that, in addition to being moveable in the direction of the pump movement, the actuating device has a further degree of freedom of movement in order to be able to assume a rest position or a functional position. This permits single-handed operation of the metering device, since the actuating device can be moved from the rest position into the functional position by applying an unlocking force. An actuating force can then be exerted on the actuating device in order to carry out a pump stroke and to feed medium out of a medium store, through the pump device and the metering duct and into the surroundings. After carrying out the pump movement, the actuating device can, in a compressed or expanded position of the pump device, be placed into the rest position by applying a locking force, so that an unintended actuation of the metering device does not result in any discharge of medium.

In one embodiment of the invention, it is provided that the at least one section of the metering head, in particular the actuating device, is displaceable in a linearly moveable fashion along a movement path, with the movement path being aligned nonparallel, in particular orthogonally, to the pump movement axis. It is possible by means of a displacement of the actuating device along a movement path to carry out a comfortable movement of the actuating device from the rest position into the functional position and back. A movement path describes a rectilinear or curved movement of the actuating device between the rest position and the functional position, and can be provided in particular by means of sliding guidance or link guidance of the actuating device relative to a further section of the metering head or the pump device. The movement path is aligned nonparallel to the pump movement axis, so as to ensure decoupling between the movement of the unlocking and locking of the actuating element and the pump movement. This makes it possible to prevent an unintended actuation of the pump device. In the case of a curved movement path, it is provided that at least one path section in the region of the rest position of the actuating device is aligned nonparallel to the pump movement axis. In a preferred embodiment of the invention, it is provided that the entire movement path is aligned at least substantially orthogonally to the pump movement axis, so as to provide decoupling, which can be easily understood by a user, between the locking and unlocking movements for the actuating device and the pump movement. For example, the pump movement axis can be aligned parallel, in particular coaxial, to a central longitudinal axis of the metering device, while the movement path for the actuating element is aligned orthogonally to the central longitudinal axis.

In a further embodiment of the invention, it is provided that the at least one section of the metering head, in particular the actuating device, is moveable in a pivotable fashion, between the rest position and the functional position, about a pivot axis which is aligned in particular orthogonally to the pump movement axis. It is possible with a pivoting movement to provide a simple to carry out locking and unlocking movement of the actuating device. The pivot axis of the actuating device can preferably be aligned orthogonally to the pump movement axis. In order to lock and unlock the actuating device, a tilting action about the pivot axis takes place, which, in the case of unlocking, is followed by a pump movement in the orthogonal direction to the pivot axis. It is possible as a result of the pivotable actuating direction to also provide a clear visual and haptic, that is to say easy-to-see and easy-to-feel, difference between the locked and unlocked positions of the actuating device, since the actuating device can be formed so as to project obliquely out from the metering head in the functional position, and thereby signalize functional readiness. In one embodiment of the invention, the actuating device can be pivoted both along a movement path and also about at least one pivot axis, so that, in the unblocked position, it is possible to individually match the position of the metering opening relative to the rest of the metering device.

In a further embodiment of the invention, it is provided that the metering duct is designed to be telescopic, in order to permit a displacement of the metering opening along the movement path. As a result of a displacement of the metering opening, it is possible to provide a compact design of metering device in the rest position, while the metering opening, which is preferably provided in the actuating device, projects out from the metering device in the manner of a spout or beak in the functional position. This provides considerable advantages in automated processes, such as in particular during filling or during assembly of the metering head. This facilitates the admission of an in particular high-viscosity, that is to say cream- or paste-like medium, which is dispensed as a compact and in particular cohesive strand of medium, for example onto the surface of a hand. In order to ensure that, despite the displacement of the metering opening, the medium can be transported from the pump device to the metering opening without any break in the metering duct, the metering duct is designed to be telescopic, that is to say variable in length, and therefore permits a relative movement of the metering opening relative to the pump device. For this purpose, the metering duct can for example be provided with a flexible element, in particular an elastic duct section or a bellows-like duct section, thereby permitting a variation in length by means of elastic deformation.

In a further embodiment of the invention, it is provided that the metering duct has a first and at least one second metering duct section, with the second metering duct section being slidably held, at least in sections, in the first metering duct section. As a result of an at least two-part design of the metering duct, with metering duct sections which are matched to one another and can slide into one another, it is possible to provide a metering duct which can be produced in particular by means of plastic injection molding and is simple to assemble. The metering duct sections can in particular have a round or polygonal cross section, with an outer contour of one metering duct section being matched to an inner contour of the further metering duct section, so that the metering duct sections can be pushed into one another in a telescopic and in particular medium-tight manner. This permits a displacement of the metering opening, and a variation in the length of the metering duct, over a range of several millimeters to centimeters.

In a further embodiment of the invention, it is provided that a sealing device is formed between the first and the second metering duct sections, which sealing device is provided to seal off the slidably arranged metering duct sections in order to prevent medium from being discharged between the metering duct sections. In order to avoid a high degree of friction, which could lead to uncomfortable operation of the actuating device, between the metering duct sections which are matched to one another, a sealing device is provided between the metering duct sections. The sealing device permits local sealing of the metering duct sections and therefore ensures a low degree of friction between the metering duct sections. The sealing device can be embodied as a separate component, for example as an O-ring, which is held in an inward-facing or outward-facing groove of a metering duct section and can slide with an in particular annular contact line, which provides a sealing action, on a substantially smooth surface of the corresponding metering duct sections. In a preferred embodiment of the invention, the sealing device is embodied as an encircling, in particular annular sealing edge or sealing lip which is integrally formed in a metering duct section and can be integrally formed already during production of the metering duct section, and therefore does not require any assembly operations.

In a further embodiment of the invention, it is provided that the at least one section of the metering head, in particular the actuating device, is assigned locking means which are designed to prevent an unintended pump movement in the rest position. The locking means allow actuating forces, which can occur in the event of an unintended actuation of the metering device and could otherwise lead to an unintended dispensing of medium, to be absorbed. The locking means are provided on the metering head in such a way that, in the rest position of the actuating device, they prevent an introduction of force into the pump device and provide a closed force flow between the actuating device, the metering head and if appropriate a medium store. As a result, there can be no relevant relative movement of the actuating device in the direction of the pump movement axis. The locking means can be provided for a linearly moveable, for a pivotably moveable or for a linearly and pivotably moveable actuating device, and in the functional position, permit a movement of the actuating device along a movement path or about a movement axis, while in the rest position, it is ensured that the actuating device is blocked.

In a further embodiment of the invention, it is provided that the locking means are designed as closure means for the metering duct in order to provide, as a hydraulic check valve, a blocking action for the actuating device. With an embodiment of the locking device as a hydraulic check valve, it is possible to fulfill a dual function of the locking means. By blocking, that is to say by sealing off, the metering duct, an actuation of the pump device is prevented by the incompressibility of the medium alone. When a metering duct is blocked, the medium, which typically cannot be compressed, enclosed in the pump device and in the blocked region of the metering duct cannot escape despite any increase in internal pressure as a result of external actuating forces, and medium is thereby prevented from being dispensed out of the pump device into the medium duct. The locking means therefore fulfill the blocking function for the actuating device and prevent medium from being unintentionally dispensed when external forces act on the actuating device. In addition, the blocking of the metering duct in the rest position also reduces or prevents a discharge or outflow of medium remaining in the metering duct, so that soiling of an outer face of the metering device or of the surroundings of the metering device can be avoided.

In a further embodiment of the invention, it is provided that the hydraulic check valve is formed between the first and the second metering duct sections and is provided to block the metering duct in the rest position. The hydraulic check valve is provided to close off the metering duct in order to prevent an unintended discharge of medium out of the metering duct. The hydraulic check valve is preferably embodied as an axially or radially acting valve, in particular as an axially acting conical valve or as a radially acting slide valve, and is driven by the substantially linear movement of the actuating device. In the case of an axially acting valve, the metering duct is blocked in its longitudinal extent during the movement from the functional position into the rest position. In the case of a radially acting valve, the axial movement of the actuating device into the rest position results in a duct section which projects out substantially orthogonally from the metering duct, and can for example be provided for a connection to the pump device or to the metering opening, being blocked. In the case of a radial valve, it is preferably provided that the telescopic metering duct sections can be moved linearly relative to one another and, as a result, an opening in a wall region of the first metering duct section can be closed off or unblocked by the for example inner metering duct section which is provided with a continuous wall. A radial valve can also be driven by a pivoting movement of the actuating device. An axially acting valve can be of more compact design, while in the case of a radially acting valve, it is possible to provide a relatively long actuating path with low valve forces, and more simple sealing.

In a further embodiment of the invention, it is provided that the locking means are designed for a pivotable actuating device as a blocking arm which, in the rest position, is aligned at least approximately parallel to a pump movement axis and is assigned a corresponding contact face for blocking a pump movement. It is possible by means of the blocking arm, for advantageous operation of the locking device, to provide as great a distance as possible, that is to say a large lever arm, between the pivot axis and the contact face which is provided in particular on the metering head, so as to ensure that the locking means are unblocked and therefore the pump movement can be carried out even with a small pivoting movement of the actuating device. The blocking arm can in particular be provided on the actuating device in such a way as to be pivoted from an inner wall region of the metering head in the direction of the central longitudinal axis of the metering head in the event of a pivoting movement of the actuating device from the rest position into the functional position. In the case of such an arrangement of the blocking arm, self-locking is ensured by means of the blocking arm in the event of an actuating force being exerted when the actuating device is in the rest position, which self-locking action can be removed merely by means of a targeted pivoting movement of the actuating device about the pivot axis.

In a further embodiment of the invention, it is provided that the metering duct is arranged in the pivotable actuating device in such a way that there is a communicating connection between the pump device and the metering opening in the functional position, and that the metering duct is closed off in the rest position. It is thereby possible to provide dual protection against an unintended dispensing of medium if the actuating device is also provided with a blocking arm. The pivotable actuating device is therefore blocked both hydraulically and mechanically in the rest position.

In a further embodiment of the invention, it is provided that the locking means are designed for a positive movement of the actuating device counter to a pump actuating direction, so that in the rest position, it is ensured that the pump device is relieved of pressure and/or that a ventilation duct for a medium store is closed off. The pump actuating direction characterizes that movement direction along the pump movement axis in which a dispensation of medium can be caused by the pump movement. In the rest position, not only should a dispensation of medium be prevented by the pump device, but it should additionally be ensured that the medium present in the pump device and in the metering duct should be under as low a pressure as possible. This prevents constant loading of the sealing devices and prevents an unintended outflow of the medium. For this purpose, the actuating device is positively moved counter to the pump actuating direction when assuming the rest position along the movement path and/or during the pivoting movement by the locking means. A volume of a pump chamber provided in the pump device can thereby be enlarged, leading to a reduction of an internal pressure in the pump device and therefore to the desired pressure relief. Alternatively or in addition, it is also possible by means of said positive movement for a ventilation duct, provided for ventilating the pump device, to be closed off. The ventilation duct permits ventilation of the medium store in particular as the pump device is reset counter to the pump actuating direction. Said ventilation is provided in order to ensure equalization of the medium volume sucked from the medium store by the pump device. As a result of the closure of the ventilation duct in the rest position of the movement device, it is possible to prevent gaseous, in particular evaporated medium constituents from escaping during a period in which the metering device is not being used. It is thereby possible in a simple way to ensure long-term stability and constant concentration of the active substances contained in the medium.

In a further embodiment of the invention, it is provided that the locking means are assigned a guide, which guides are designed for a superposition of a positive movement of the actuating device counter to the pump actuating direction when assuming the rest position along the movement path. When assuming the rest position, the actuating device, in the manner of a wedge, is positively moved counter to the pump actuating direction by means of a guide which can also be embodied as a substantially inclined or curved face. The desired pressure relief of the pump device and the closure of the medium duct can be provided in this way. It is advantageously possible for guidance tolerances such as height tolerances or the like to be compensated in this way.

In a further embodiment of the invention, it is provided that the metering head is produced in a multicomponent injection molding process, with it being possible for components which are moveable relative to one another to be produced in successive working steps. It is possible with the multicomponent injection molding process for the different sections of the metering head, that is to say also the moveable actuating device, to be produced in a sequence of a plurality of injection molding processes in one single injection molding tool, without it being subsequently necessary to carry out assembly operations. For the multicomponent injection molding process, it is provided that initially a first section of the metering head is produced in the injection mold using a plastic material which preferably has a high melting point. A second section of the metering head is subsequently produced using a material which preferably has a low melting point, that is to say a plastic material with a relatively low melting point, in the same injection mold after actuating one or more mold slides. It is possible to carry out further injection molding processes using plastic materials with lower melting points in each case. It is also conceivable to produce elastic sealing devices which are directly sprayed on to the metering head sections which are formed from a relatively hard plastic material.

In a further embodiment of the invention, it is provided that the metering duct is assigned a suck-back device which is arranged in particular on the actuating device, so that it is possible to avoid an excess of medium in the metering duct when the actuating device is in the rest position. It is possible by means of the suck-back device for the medium held in the metering duct to be at least partially pulled back from the metering opening as the actuating device is moved from the functional position into the rest position, so that a discharge of medium can be avoided in the rest position, since the medium is at least partially sucked from the metering opening into a storage chamber of the suck-back device. This is of particular interest in the case of a medium which poses a soiling or drying-out risk for the metering device and its surroundings, as can be the case with, for example, a cream or gel. The suck-back device is used in particular in the case of a telescopic metering duct whose duct volume is reduced by the telescopic movement when moving into the rest position, as a result of which the medium held in the metering duct would be discharged through the metering opening. The suck-back device prevents said discharge in that at least the volume difference between the telescopically extended metering duct and the retracted metering duct is sucked into the suck-back device by a vacuum.

In a further embodiment of the invention, it is provided that the suck-back device is designed as a piston pump with a cylinder and a piston for sucking back medium, with it being possible for the piston to be driven by a movement of the actuating device along the movement path. It is thereby possible to provide an effective and simple to construct suck-back device. With suitable dimensioning, the suck-back device makes it possible to suck a medium volume which is at least as large as the volume reduction of the telescopic metering duct during the movement from the functional position into the rest position. The suck-back device can preferably suck back a medium volume which is greater than the volume reduction of the metering duct caused by the telescopic movement, so that the medium remaining in the medium duct is pulled back from the metering opening and cannot lead to soiling. As the actuating device is moved from the rest position into the functional position, the medium is ejected from the suck-back device and pushed in the direction of the metering opening, so that, in the event of a pump movement, the medium can be directly dispensed out of the metering opening.

Further advantages and features can be gathered from the claims and from the following description of preferred exemplary embodiments which are illustrated on the basis of the drawings, in which:

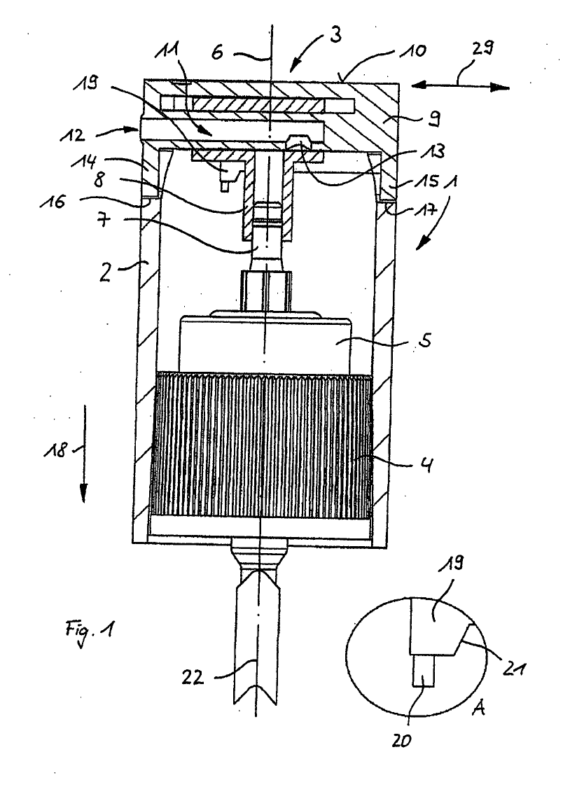

FIG. 1 shows a metering head with a linearly moveable actuating device and a radial valve in a rest position,

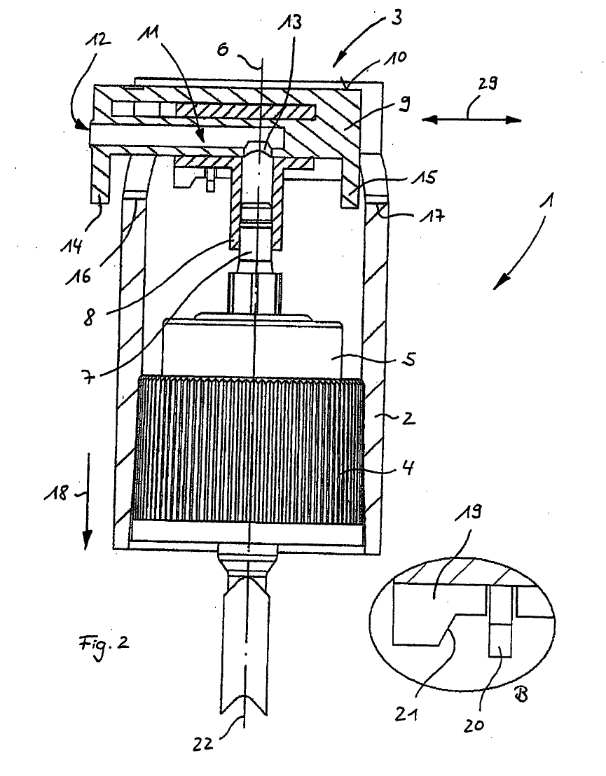

FIG. 2 shows the metering head from FIG. 1 in a functional position,

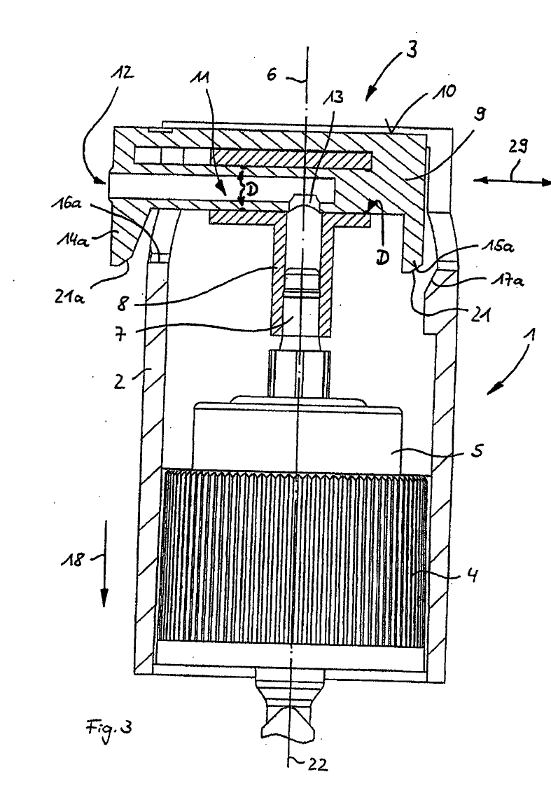

FIG. 3 shows a further embodiment of a metering head in the functional position, and

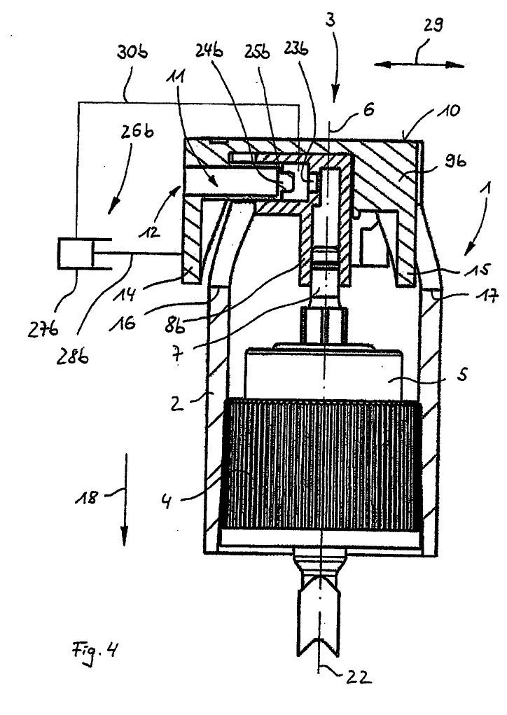

FIG. 4 shows a further embodiment of a metering head, having an axial valve, in the functional position.

A metering head 1 for a metering device (not illustrated in any more detail) has a first section, which is designed as a sleeve-shaped housing 2, and a second section which is designed as an actuating device 3. The sleeve-shaped housing 2 encloses a screw closure 4 which is provided with an integrated pump device 5 and is provided to be screwed on to a medium store (not illustrated). The pump device 5 is embodied as a piston pump (not illustrated in any more detail) and has an upwardly projecting pump plunger 7 which is linearly moveable along a pump movement axis 6. The pump plunger 7 has an outlet opening (not illustrated) which is arranged concentrically with respect to a central longitudinal axis 22 of the pump device 5 and permits an outflow of fed medium out of the pump device 5. The pump plunger 7 is coupled to a pump piston (not illustrated) which is moveably held in a pump chamber of the pump device 5. A first metering duct section 8 is pushed onto the pump plunger 7, which first metering duct section 8 is illustrated in section and is designed substantially as a T-shaped tube piece. A second, tubular metering duct section 9 is slidably held in the first metering duct section 8, which second metering duct section 9 is integrally connected to an actuating device designed as a finger rest 10. At an outer face of the finger rest 10, the metering duct 11 which is delimited by the metering duct sections 8, 9 opens out into a metering opening 12 which in the present case is of cylindrical design.

The metering duct sections 8, 9 are matched to one another in such a way that they can be slidably displaced in a sealing fashion relative to one another. In order to provide sealing between the metering duct sections 8, 9, the outer contour of the second metering duct section 9 is matched to the inner contour of the metering duct section 8 in such a way that the metering duct sections are in contact with one another in an encircling line of contact (not illustrated). The medium can therefore only penetrate to a small extent into a gap between the metering duct sections 8, 9, and can advance only as far as the line of contact. In addition, encircling sealing means D, in particular at least one encircling, integrally formed sealing ring, is provided between the metering duct sections 8 and 9.

In order to block the metering duct 11 in the rest position as per FIG. 1, a connecting bore 13 is formed in a wall region of the second metering duct section 9 in such a way as to be closed off in the rest position by a wall section of the first metering duct section. In the functional position illustrated in FIG. 2, the connecting bore 13 is arranged relative to the first metering duct section 8 in such a way that a communicating connection is produced between the outlet opening and the metering duct 12. The two metering duct sections 8 and 9 thereby form a hydraulic check valve in the form of a radial valve, which can be driven by means of a linear displacement of the metering duct sections 8, 9 relative to one another. The design of the metering duct sections 8, 9 according to FIGS. 1, 2 and 3 is a first embodiment of a metering duct 11 in which, despite a relative movement of the metering duct sections 8, 9, no change in volume takes place in the metering duct 11. The problem of an unintended dispensing of medium when moving the finger rest 10 from the functional position into the rest position is therefore considerably reduced or eliminated in said embodiment. A telescopic metering duct 11 with variable volume is described in the following for the embodiment shown in FIG. 4.

Blocking of the finger rest 10 so as to prevent an unintended pump movement is also ensured, in addition to the hydraulic blocking function by the radial valve in the metering head 1 as per FIGS. 1 and 2, by the downward-projecting front and rear tongues 14, 15 which, in the rest position, bear against contact faces 16, 17 of the first section of the metering head 1 and thereby prevent a movement of the finger rest 10 in the direction of the pump device 5. As a result of the linear displacement of the finger rest 10 between the rest position as per FIG. 1 and the functional position as per FIG. 2, the tongues 14, 15 are also removed from the contact faces 16, 17 and thereby permit a pump movement. The pump movement takes place along the pump movement axis 6 in the pump movement direction 18, and leads to a metering of medium out of the pump device 5 into the metering duct 11 and to the metering opening 12. The pump device 5 is provided with a return spring (not illustrated) which resets the finger rest 10 into the initial position illustrated in FIG. 2, and thereby also permits a purely translatory displacement of the actuating device back into the rest position.

During the linear displacement of the finger rest 10 between the rest position and the functional position as per FIGS. 1 and 2, which can also be described as a movement along a substantially rectilinear movement path 29, an additional guide device which is embodied as a control slot 19 is driven. The control slot 19, which is illustrated in the rest position and in the functional position in the enlarged detail views A and B of FIGS. 1 and 2, is connected to the finger rest 10 and is therefore guided along the movement path by the movement. The control slot 19 is arranged adjacent to a support pin 20 attached to the housing 2 and can, depending on the position of the finger rest 10, come into operative connection with the support pin 20. The control slot 19 is provided with an inclined face 21, that is to say a type of oblique plane, which is aligned at an angle to the movement path and, as the finger rest 10 moves from the functional position into the rest position, causes a translatory positive movement of the finger rest counter to the pump movement direction 18. The pump piston (not illustrated) is thereby, in addition to a return force which can be exerted by a spring device (not illustrated), pulled upward counter to the pump movement direction 18, so that on the one hand, a volume of the pump chamber is enlarged and the medium held in the pump chamber is relieved of pressure. On the other hand, said movement can also serve to close off a ventilation device (not illustrated) which is assigned to the pump device 5, in order to prevent gaseous or evaporated medium constituents from escaping while the metering device is not being used.

It can in particular be provided here that the ventilation valve of the pump device 5 is closed off directly at the beginning of the movement of the finger rest 10 from the functional position into the rest position, that is to say as the metering device is deactivated. It is thereby possible by means of the subsequent positive movement, caused by the control slot 19 and the support pin 20, of the finger rest 10 counter to the pump movement direction 18, which positive movement is associated with the enlargement of the volume enclosed by the pump chamber and the pump piston, for a vacuum to be generated in the pump chamber. The vacuum leads to at least slight back suction of medium into the pump chamber and thereby prevents a discharge of medium out of the metering opening 12 during or after the deactivation of the metering device.

In the embodiment as per FIG. 3, which has the same reference symbols as the embodiment in FIGS. 1 and 2 for functionally identical components, instead of the control slot 19, in each case one inclined face 21a is provided on the front and rear tongues 14a, 15a and correspondingly on the contact faces 16a and 17a of the housing 2, so that the positive movement of the finger rest 10 is caused merely by the operative connection of the tongues 14a, 15a to the contact faces 16a, 17a.

The embodiment as per FIG. 4, which has the same reference symbols as the previously described embodiments for functionally identical components, differs from the embodiments of FIGS. 1 to 3 by the design of the metering duct sections 8b, 9b. The metering duct section 8b is of substantially L-shaped design, and is provided with an aperture 23b which is designed as a valve seat for an axial valve. The second metering duct section 9b has a sleeve-shaped design and is provided with a valve plug 24b at an end facing towards the first metering duct section 8b. The valve plug 24b is matched in terms of its geometric design to the aperture 23b and can be sealingly held in the opening of the aperture 23b. A passage opening 25b is provided on the side of the valve plug 24b, which passage opening 25b, in the functional position illustrated, ensures a communicating connection between the metering duct sections 8b and 9b and therefore between the outlet opening and the metering opening 12. The axial valve formed by the aperture 23b and the valve plug 24b can be opened and closed by a linear movement of the finger rest 10 between the rest position and the functional position, and acts as a hydraulic check valve which, in the closed state, as a result of the incompressibility of the medium, can prevent an actuation of the pump device 5.

In order to prevent an unintended dispensation of medium during the movement of the finger rest 10 from the illustrated functional position into the rest position, which movement is associated with a reduction in the volume delimited by the metering duct 11b, it is possible to provide a suck-back device 26 (illustrated only schematically in FIG. 4). The suck-back device 26b is embodied as a piston pump having a cylinder 27b and a piston 28b for sucking back medium. The cylinder 27b is connected to the housing 2 in a way not illustrated in any more detail. The piston 28b can be driven by a movement of the finger rest 10 along the movement path 29 and increases the size of a volume enclosed by the cylinder 27b and the piston 28b during the movement of the finger rest 10 from the functional position into the rest position. Since the cylinder 27b is connected by means of a suction line 30b to the metering duct 11b, it is possible with suitable dimensioning of the suck-back device 26b for the entire medium volume displaced by the telescopic movement of the metering duct to be sucked back.

1. Metering device for manual, in particular single-handed metering of a medium, having a pump device (5) which can be operated by means of a pump movement (18) in order to feed the medium and is assigned a metering head (1) which has an actuating device (10) which is moveably coupled to the pump device (5) in order to introduce the pump movement (18), characterized in that at least one section of the metering head (1), in particular the actuating device (10), has an integrated metering duct (11, 11b) for transporting the fed medium from the pump device (5) to a metering opening (12), and is moveable between a rest position and a functional position in order to block or unblock the actuating device (10) for the pump movement.

2. Metering device according to claim 1, characterized in that the at least one section of the metering head (1), in particular the actuating device (10), is displaceable along a movement path (29) between the rest position and the functional position, with the movement path (29) being aligned nonparallel, in particular orthogonally, to the pump movement axis (6).

3. Metering device according to claim 1, characterized in that the at least one section of the metering head (1), in particular the actuating device (10), is pivotable, between the rest position and the functional position, about a pivot axis which is aligned in particular orthogonally to the pump movement axis (6).

4. Metering device according to claim 2, characterized in that the metering duct (11, 11b) is designed to be telescopic, in order to permit a displacement of the metering opening (12) along the movement path (29).

5. Metering device according to claim 4, characterized in that the metering duct (11, 11b) has a first (8, 8b) and at least one second (9, 9b) metering duct section, with the second metering duct section (9, 9b) being slidably held, at least in sections, in the first metering duct section (8, 8b).

6. Metering device according to claim 5, characterized in that a sealing device is formed between the first (8, 8b) and the second (9, 9b) metering duct sections, which sealing device is provided to seal off the slidably arranged metering duct sections (8, 8b, 9, 9b) in order to prevent medium from being discharged between the metering duct sections (8, 8b, 9, 9b).

7. Metering device according to claim, characterized in that the at least one section of the metering head (1), in particular the actuating device (10), is assigned locking means (13, 14, 14a, 15, 15a, 16, 16a, 17, 17a, 19, 20, 24b, 25b) which are designed to prevent an unintended pump movement in the rest position.

8. Metering device according to claim, characterized in that the locking means are designed as closure means (13, 24b, 25b) for the metering duct (11, 11b) in order to provide, as a hydraulic check valve, a blocking action for the actuating device (10).

9. Metering device according to claim 8, characterized in that the hydraulic check valve is formed between the first (8, 8b) and the second (9, 9b) metering duct sections and is provided to block the metering duct (11, 11b) in the rest position.

10. Metering device according to claim 8, characterized in that the metering duct (11, 11b) is arranged in the pivotable actuating device (10) in such a way that there is a communicating connection between the pump device (5) and the metering opening (12) in the functional position, and that the metering duct (11, 11b) is closed off in the rest position.

11. Metering device according to claim 8, characterized in that the locking means (14a, 15a, 16a, 17a, 20, 21, 21a) are designed for a positive movement of the actuating device (10) counter to a pump actuating direction (18), so that in the rest position, it is ensured that the pump device (5) is relieved of pressure and/or that a ventilation duct for a medium store is closed off.

12. Metering device according to claim 11, characterized in that the locking means (14a, 15a, 16a, 17a, 20, 21, 21a) are assigned at least one guide, which guides are designed for a superposition of a positive movement of the actuating device (10) counter to the pump actuating direction (18) when assuming the rest position along the movement path (29).

13. Metering device according to claim, characterized in that the metering head (1) is produced in a multicomponent injection molding process, with it being possible for components which are moveable relative to one another to be produced in successive working steps.

14. Metering device according to claim, characterized in that the metering duct (11, 11b) is assigned a suck-back device (26b) which is arranged in particular on the actuating device (10), so that it is possible to avoid an excess of medium in the metering duct (11, 11b) when the actuating device (10) is in the rest position.

15. Metering device according to claim 14, characterized in that the suck-back device is designed as a piston pump with a cylinder (27b) and a piston (28b) for sucking back medium, with it being possible for the piston (28b) to be driven by a movement of the actuating device (10) along the movement path (29).
